(19) United States
(12) Patent Application Publication
(10) Pub. No.: US 2008/0276537 A1
(43) Pub. Date: Nov. 13, 2008

(54) LIFTGATE DRIVE UNIT

(75) Inventors: Ronald J. Hanna, Mancelona, MI (US); Adam W. Remesz, Clinton Township, MI (US)

Correspondence Address: GIFFORD, KRASS, SPRINKLE,ANDERSON & CITKOWSKI, P.C, PO BOX 7021, TROY, MI, 48007-7021, US

(73) Assignee: Dura Global Technologies, Inc.

(21) Appl. No.: 11/841,260

(22) Filed: Aug. 20, 2007

Related U.S. Application Data
(63) Continuation-in-part of application No. 11/746,248, filed on May 9, 2007.

(51) Int. Cl. E05F 11/24

(52) U.S. Cl. 49/343

(57) ABSTRACT

A drive unit for driving a liftgate of a motor vehicle between closed and open positions. The drive unit includes an extendable strut having an outer tube and an inner tube coupled telescopically for movement between retracted and extended positions corresponding with the closed and open positions of the liftgate, respectively. The drive unit includes a drive screw mechanism for retracting and extending the extendable strut. The drive unit also includes a motor and gear set for actuating the drive screw, wherein the motor and gear set are supported by one of the outer and inner tubes of the extendable strut. The drive screw mechanism utilizes a ball bearing for translating rotational movement of the drive screw into translational movement of a housing and the inner tube interconnected therewith.

### REFERENCE TO RELATED APPLICATIONS

This application is a continuation-in-part of co-pending U.S. patent application Ser. No. 11/746,248 filed on May 9, 2007, which is incorporated herein by reference in its entirety.

### FIELD OF THE INVENTION

The invention relates to a drive unit for use a liftgate of a motor vehicle. More particularly, the invention relates a liftgate drive unit having a ball-screw mechanism and a housing for supporting the ball-screw mechanism.

### BACKGROUND OF THE INVENTION

Automotive vehicles typically include a cargo space and an entrance formed in a vehicle wall providing access to the cargo space. Some vehicles, such as sport utility vehicles or vans, also typically include a liftgate, which covers the entrance in a closed position and which movable to an open position to allow access to the cargo space through the entrance Liftgates can be made to swing horizontally or vertically between the closed and open positions. In the latter case, it is known to provide a dampener or strut to bias and hold the liftgate toward the open position. It is also known to provide an actuator for automatically moving the liftgate between the closed and open positions.

It remains desirable to design a compact drive unit that integrates a strut and an actuator that is compact in size while maintaining or exceeding the performance of conventional struts and actuators.

### SUMMARY OF THE INVENTION

According to one aspect of the invention, a drive unit is provided for driving a liftgate of a motor vehicle between closed and open positions. The drive unit includes an extendable strut and a drive unit. The strut has inner and outer tubes telescopically engaged for movement between retracted and extended positions corresponding with the closed and open positions of the liftgate, respectively. The drive unit drives the strut between the retracted and extended positions. The drive unit has a drive screw coupled to one of the inner and outer tubes and a housing coupled to the other of the one of the inner and outer tubes. The drive screw is rotatable about a longitudinal axis of the drive screw. The drive unit has at least one ball bearing rollingly supported in a generally helically-shaped groove in the drive screw. The ball bearing is retained in the groove by the housing so that rotation of the drive screw about the longitudinal axis imparts a generally axial force which causes corresponding translation of the housing along the longitudinal axis.

According to another aspect of the invention, a drive unit is provided for driving a liftgate of a motor vehicle between closed and open positions. The drive unit includes an extendable strut having an outer tube and an inner tube coupled telescopically for relative axial movement between retracted and extended positions corresponding with the closed and open positions of the liftgate, respectively. The drive unit also includes a drive screw mechanism having a drive screw extending along a longitudinal axis and being rotatable about the longitudinal axis for actuating the extendable strut. The drive screw mechanism has a ball bearing for transferring the rotational movement of the drive screw into generally axial movement of the strut between the retracted and extended positions.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a perspective view of a rear end of a vehicle having a drive unit for actuating a tailgate between closed and open positions;

FIG. 2 is a side elevational view of the drive unit;

FIG. 3 is an enlarged perspective view of the drive unit which has been cutaway to show a drive screw mechanism therein;

FIG. 4 is a cross sectional view of the drive unit.

### DESCRIPTION OF THE INVENTION

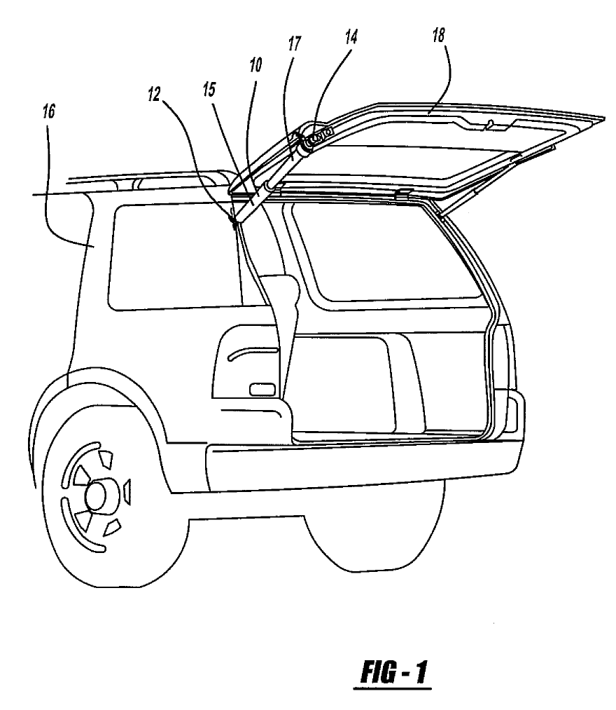

Referring to FIG. 1, a liftgate drive unit according to one embodiment is generally indicated at 10. The drive unit 10 drives a liftgate 13 between closed and opened positions relative to a vehicle body 19. The drive unit 10 includes an extendable strut 12 movable between retracted and extended positions. The strut 12 includes an outer tube 15 having a hollow interior 30 and an inner tube 17 disposed within the interior 30 of the outer tube 15. The outer 15 and inner 17 tubes are telescopically engaged for movement between the retracted and extended positions. Illustratively, the outer tube 15 is shown coupled to the vehicle and the inner tube is coupled to the liftgate so that movement of the strut 12 between the retracted and extended positions causes movement of the liftgate between the closed and open positions, respectively. The drive unit 10 includes a motor-driven drive screw and a housing threadingly engaged therewith for actuating the strut between the retracted and extended positions.

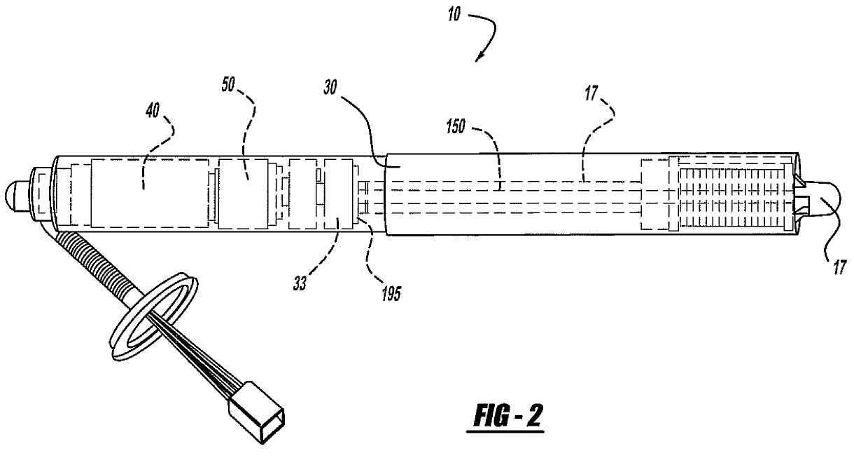

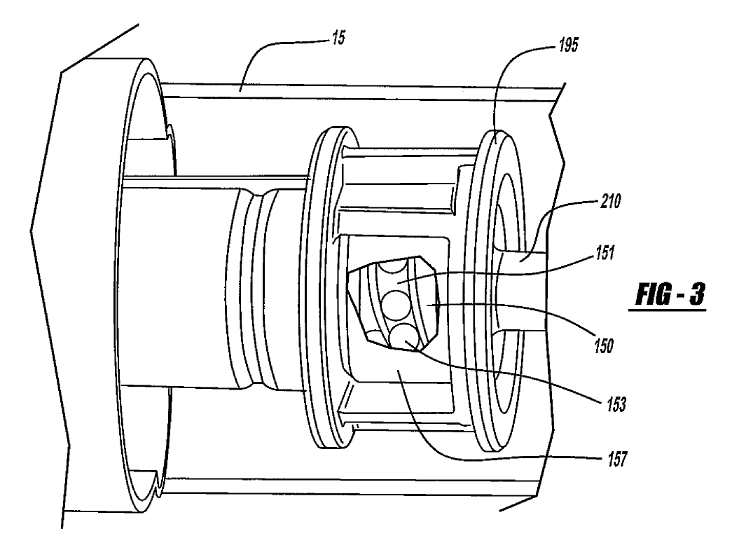

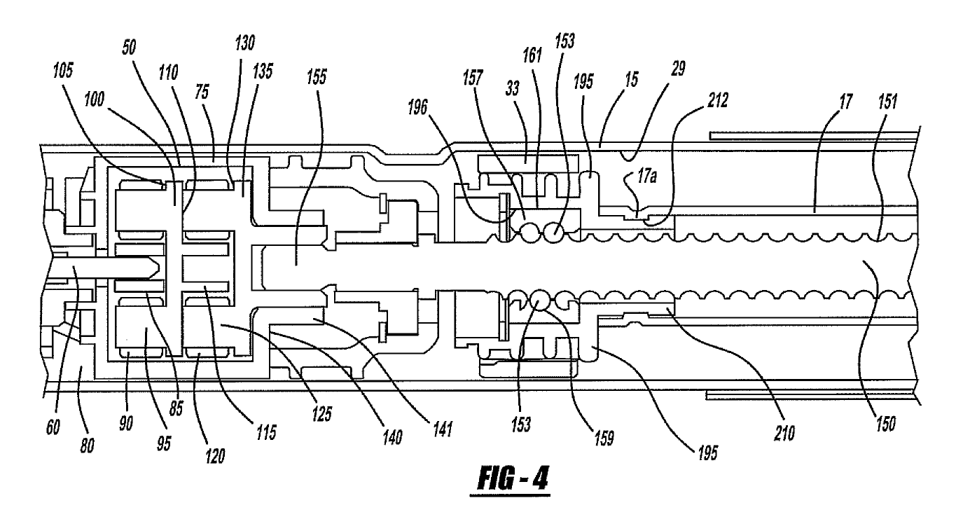

Referring to FIGS. 2-4, the drive screw 150 is rotatably coupled to the outer tube 15 for rotation about a longitudinal axis of the drive screw 150. The drive screw 150 includes a generally helical groove 151 extending about the longitudinal axis. The drive screw 150 has opposite first 155 and second 160 ends. The first end 155 is splined for coupling the drive screw 150 to a motor assembly 40. A bearing assembly 170 supports the drive screw 150 within the hollow interior 30 of the outer tube 15 and provides free rotation of the drive screw 150 within the outer tube 15.

At least one ball bearing 153 is rolling supported in the groove 151 of the drive screw 150. A drive nut or housing 195 is positioned about a circumference of the drive screw 150 and is slidably supported along an inner bearing surface 29 of the outer tube 15. A bushing 33 is positioned between the housing 195 and the inner bearing surface 29 of the outer tube 15. The bushing 33 may be press fit or otherwise axially coupled to the housing 195 for movement therewith.

A generally annular-shaped bearing support 157 is disposed between an inner surface 196 of the housing 195 and the drive screw 150. The inner surface 196 of the housing 195 and a corresponding outer surface 161 of the bearing support 157 are shaped to prevent rotation of the bearing support 157 relative to the housing 195 and to axially couple the bearing support 157 to the housing 195. The bearing support 157 includes a groove 159 corresponding with the groove 151 in the drive screw 150. The ball bearing 153 is rollingly supported and retained between the grooves 151, 159 of the drive screw 150 and the housing 195. The ball bearing 153 translates rotational movement of the drive screw 150 about the longitudinal axis into a generally axial force that displaces the housing 195 along the longitudinal axis of the drive screw 150. The drive unit 10 may have a plurality of ball bearings 153 for translating the rotational movement of the drive screw 150 into generally axial movement of the housing 195 along the drive screw 150.

The housing 195 includes a reduced diameter portion 210 formed thereon, which extends into an end of the inner tube 17. A portion 17a of the inner tube 17 protrudes into a recess 212 formed in the reduced diameter portion 210, thereby axially coupling the housing 195 to the inner tube 17. The portion of the inner tube 17 that extends into the recess 212 may be a preformed tab or other similar protruding feature.

The housing 195 may be formed from any suitable material and forming process. The housing 195, for example, may be formed of die-cast metal or metal alloy. Alternatively, the housing 195 may be formed as an injection molded component. In this case, the bearing support 157 and/or bearing(s) 153 may be insert-molded with the housing 195. Alternatively, the housing 195 may be formed as a plurality of molded parts that are subsequently fixedly coupled together in a subsequent operation.

A motor assembly 40 is disposed in the outer tube 15 and is operatively coupled to the drive screw 150 for telescopically driving the inner tube 17 relative to the outer tube 15. The motor assembly 40 includes an electrical motor 55 having a rotating output drive shaft 60 extending therefrom. A transmission assembly 50 mechanically couples the drive shaft 60 and the drive screw 150. An electrical wire and connector 65 provides electricity to the motor 55.

The transmission assembly 50 is epicyclical and includes a gear housing 75 in which the various transmission components are disposed. The gear housing 75 includes an end cap 80 for sealing the transmission components within the gear housing 75 and allowing passage of the drive shaft 60 of the electric motor 55. The drive shaft 60 may extend in any manner from the motor 55, but in one aspect it extends co-lineally with respect to the inner tube 17. The drive shaft 60 from the electric motor 55 is coupled to a pinion gear 85.

Surrounding the pinion gear 85 is a first set of planetary gears 90. The first set of planetary gears 90 is disposed on shafts 95 extending from a first carrier plate 100 on a first side 105 of the carrier plate 100. The second side 110 of the first carrier plate 100 includes a pinion gear 115 extending therefrom. The pinion gear 115 on the first carrier plate 100 is surrounded by a second set of planetary gears 120. The second set of planetary gears 120 is disposed on shafts 125 extending a first surface 130 of a second carrier plate 135. A second side 140 of the second carrier plate 135 includes a spline engagement feature 141 extending therefrom for linking with the first end 155 of the drive screw 150. The transmission assembly 50 components may be made of plastic, composite or other suitable materials including metal, and powdered metal. As stated above, the motor assembly 40 and the transmission assembly 50 may be disposed within the inner tube 17, which provides improved packaging of a liftgate drive unit 10. While the transmission assembly 50 has been described as having first 90 and second 120 sets of planetary gears, various numbers of planetary gears may used by the present invention to achieve the design characteristics of various vehicle liftgates. A more detailed description of the motor and transmission assemblies is provided in co-pending U.S. patent application Ser. No. 11/746,248 filed on May 9, 2007, which is incorporated herein by reference.

In use, the drive unit 10 may be attached at one end to a liftgate of a vehicle and at another end to the body of a vehicle. In the illustrated embodiment, the end of The drive unit 10 having the motor assembly 40 is attached to the vehicle body, while the opposite end of The drive unit 10 is attached to the liftgate 18. The drive screw 150 is rotatably driven by its longitudinal axis by the motor 40 and transmission 50 assemblies, as described above. Rotation of the drive screw 150 causes the housing 195 to travel axially along the drive screw 150. More specifically, the ball bearing 153 rolls along the groove 151 in the drive screw 150. The helical path of the groove 151 causes the drive screw 150 to impart an axial component of force upon the ball bearing 153, which in turn displaces the ball bearing 153 in an axial direction relative to the drive screw 150. The housing 195 moves with the ball bearing 153 relative to the drive screw 150 due to the retention of the ball bearing 153 in the corresponding groove 159 in the bearing support 157. As stated above, the housing 195 is axially coupled to the inner tube 17. Therefore, travel of the housing 195 axially along the drive screw 150 causes longitudinal movement of the inner tube 17 therewith relative to the outer tube 15. Any suitable sensor, switch and/or control may be provided for shutting off the motor 55 when the inner tube 17 has reached a predetermined position, such as the retracted position or the extended position.

The liftgate 13 reaches the fully open position when the drive unit 10 reaches the fully extended position. The liftgate 13 may be returned to the closed position by returning the drive unit 10 to the retracted position. The drive unit 10 may be returned to the retracted position by rotating the motor 55 in an opposing direction, or if the motor 55 is not utilized an operator may exert a force on a liftgate, thereby back driving the electric motor 55 through the transmission. Optionally, a clutch may be positioned between the transmission assembly 50 and the drive screw 150 such that the drive screw 150 will be back driven separately from the motor and transmission assemblies 40, 50. The clutch may be a roller type mechanical or an electromagnetic clutch or may be a lead screw clutch that travels up and down a drive screw. An example of such a mechanism is disclosed in U.S. patent application Ser. Nos. 11/406,104 and 60/732,735, the descriptions of which are herein incorporated by reference.

The invention has been described in an illustrative manner. It is, therefore, to be understood that the terminology used is intended to be in the nature of words of description rather than of limitation. Many modifications and variations of the invention are possible in light of the above teachings. For example, the connections of the outer tube and inner tube to the vehicle body and liftgate, respectively, may be reversed. Further, any suitable materials may be used for any of the aforementioned components of the drive unit. Thus, within the scope of the appended claims, the invention may be practiced other than as specifically described.

I claim:

1. A drive unit for driving a liftgate of a motor vehicle between closed and open positions, said drive unit comprising:
an extendable strut having inner and outer tubes telescopically engaged for movement between retracted and extended positions corresponding with the closed and open positions of the liftgate, respectively; and
a drive unit driving the strut between the retracted and extended positions, the drive unit having a drive screw coupled to one of the inner and outer tubes and a housing coupled to the other of the one of the inner and outer tubes, the drive screw being rotatable about a longitudinal axis of the drive screw,
the drive unit having at least one ball bearing rollingly supported in a generally helically-shaped groove in the drive screw, the ball bearing being retained in the groove by the housing so that rotation of the drive screw about the longitudinal axis imparts a generally axial force which causes corresponding translation of the housing along the longitudinal axis.

2. A drive unit as set forth in claim 1, wherein the housing includes a generally cylindrical inner surface that retains the at least one ball bearing in the groove of the drive screw.

3. A drive unit as set forth in claim 2 including a generally annular bearing support disposed between the inner surface of the housing and the drive screw, the bearing support having a groove corresponding with the groove in the drive screw, the ball bearing being rollingly supported and retained in the grooves of the drive screw and bearing support.

4. A drive unit as set forth in claim 3, wherein the bearing support is axially coupled to the housing and translates therewith along the longitudinal axis of the drive screw in response to rotation of the drive screw about the longitudinal axis.

5. A drive unit as set forth in claim 1, wherein the housing is generally cylindrically shaped and includes a reduced diameter portion.

6. A drive unit as set forth in claim 5, wherein an end of the inner tube extends over the reduced diameter portion and is adapted to be fixedly secured thereto, such that the inner tube translates relative to the outer tube in response to the rotation of the drive screw about the longitudinal axis.

7. A drive unit as set forth in claim 6, wherein the reduced diameter portion includes an annular slot that receives a portion of the inner tube therein, thereby axially coupling the inner tube to the housing.

8. A drive unit as set forth in claim 1 including a bushing disposed between an outer surface of the housing and an adjacent surface of the other of the one of the inner and outer tubes.

9. A drive unit as set forth in claim 1 including a biasing member disposed between the inner and outer tubes to bias the strut toward the extended position.

10. A drive unit as set forth in claim 1 including a motor and gear set for actuating the drive screw, the motor and gear set being supported by one of the outer and inner tubes of the extendable strut.

11. A drive unit as set forth in claim 10, wherein the motor includes an outwardly extending drive shaft that is substantial coaxial with the gear set, the gear set being engaged with the drive screw for driving the strut between the retracted and extended positions in response to rotation of the drive shaft of the motor.

12. A drive unit as set forth in claim 11, wherein the motor and gear set are supported within a hollow interior of the outer tube.

13. A drive unit as set forth in claim 12, wherein the drive shaft is substantially coaxial with respect to the inner tube.

14. A drive unit as set forth in claim 11, wherein the gear set is a planetary gear set which includes: a main pinion gear coupled with the drive shaft, a first carrier plate, a first set of planetary gears meshed with the main pinion gear and supported by the first carrier plate, a carrier plate pinion gear supported by the first carrier plate, a second carrier plate, a second set of planetary gears meshed with the carrier plate pinion gear and supported on the second carrier plate, and wherein the second carrier plate is connected to a screw.

15. A drive unit as set forth in claim 10, wherein the extendable strut includes a tailgate connector on one side and a vehicle body connector on another side, the motor being positioned on the same side of the strut as the vehicle body connector.

16. A drive unit for driving a liftgate of a motor vehicle between closed and open positions, said drive unit comprising:
an extendable strut having an outer tube and an inner tube coupled telescopically for relative axial movement between retracted and extended positions corresponding with the closed and open positions of the liftgate, respectively;
a drive screw mechanism having a drive screw extending along a longitudinal axis and being rotatable about the longitudinal axis for actuating the extendable strut, the drive screw mechanism having a ball bearing for transferring the rotational movement of the drive screw into generally axial movement of the strut between the retracted and extended positions.

17. A drive unit as set forth in claim 16, wherein the ball bearing is rollingly supported in a generally helical groove in the drive screw.

18. A drive unit as set forth in claim 17, wherein the ball bearing is retained in the groove by an inner cylindrical surface of a housing.

19. A drive unit as set forth in claim 18, wherein the drive screw is rotatably coupled to the outer tube.

20. A drive unit as set forth in claim 19, wherein the housing is coupled to the inner tube for translation therewith in response to the rotation of the drive screw about the longitudinal axis.
